(19) United States
(12) Patent Application Publication
(10) Pub. No.: US 2017/0229710 A1
(43) Pub. Date: Aug. 10, 2017

(54) ANODE ELECTRODE MATERIAL AND LITHIUM ION BATTERY USING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Guan-Nan Qian, Suzhou (CN); Xiang-Ming He, Beijing (CN); Li Wang, Beijing (CN); Yu-Ming Shang, Beijing (CN); Jian-Jun Li, Beijing (CN); Jing Luo, Suzhou (CN); Cheng-Hao Xu, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/498,837

(22) Filed: Apr. 27, 2017

Related U.S. Application Data
(63) Continuation of application No. PCT/CN2015/091991, filed on Oct. 15, 2015.

(30) Foreign Application Priority Data
Oct. 29, 2014 (CN) 201410591499.8

(51) Int. Cl. H01M 4/62; H01M 4/485; H01M 4/131; H01M 4/587; H01M 10/0525; H01M 4/133

(52) U.S. Cl. CPC H01M 4/622; H01M 10/0525; H01M 4/133; H01M 4/131; H01M 4/587; H01M 4/485

(57) ABSTRACT

An anode binder, a cathode electrode material, and a lithium ion battery are disclosed. The anode binder includes a polymer obtained by polymerizing a dianhydride monomer with a diamine monomer. The anode electrode material includes an anode active material, a conducting agent, and the anode binder. The lithium ion battery includes an anode electrode, an electrolyte, a separator, and the cathode electrode, the cathode electrode comprising a cathode active material, a conducting agent, and the anode binder.

### CROSS-REFERENCE TO RELATED APPLICATIONS

This application claims all benefits accruing under 35 U.S.C. §119 from China Patent Application No. 201410591499.8, filed on Oct. 29, 2014 in the State Intellectual Property Office of China, the content of which is hereby incorporated by reference. This application is a continuation under 35 U.S.C. §120 of international patent application PCT/CN2015/091991 filed on Oct. 15, 2015, the content of which is also hereby incorporated by reference.

### FIELD

The present disclosure relates to anode electrode materials having anode binders, and lithium ion batteries using the anode electrode materials.

### BACKGROUND

Binder is an important component of a cathode electrode and an anode electrode of a lithium ion battery. The binder is a high molecular weight compound for adhering an electrode active material to a current collector. A main role of the binder is to adhere and maintain the electrode active material, stabilize the electrode structure, and buffer an expansion and contraction of the electrode during a charge and discharge process. Besides having an adhering ability, the binder used in the lithium ion battery should be stable in an operation voltage range and temperature range, have relatively low inherent resistance to avoid obstructing normal charge and discharge cycling, and be insoluble to the organic solvent that is used in an electrolyte liquid of the lithium ion battery. A commonly used binder in lithium ion batteries include organic fluorine-containing polymers, such as polyvinylidene fluoride (PVDF).

### BRIEF DESCRIPTION OF THE DRAWINGS

Implementations are described by way of example only with reference to the attached figures.

FIG. 1 is a graph showing cycling performance of Example 2 of a lithium ion battery.

### DETAILED DESCRIPTION

A detailed description with the above drawings is made to further illustrate the present disclosure.

In one embodiment, an anode binder of a lithium ion battery is provided. The anode binder is a polymer obtained by polymerizing a dianhydride monomer with a diamine monomer.

The dianhydride monomer can be represented by the formulas I, II, or III below.

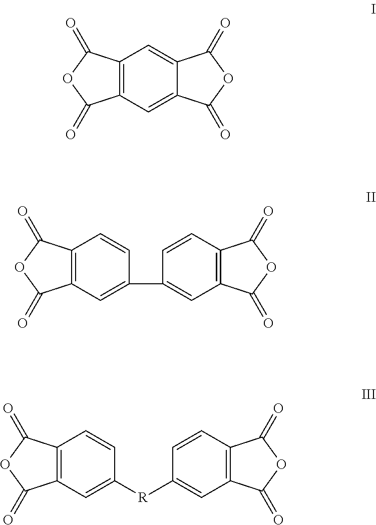

In the formula III, R is a bivalent organic substituent, which can be bisphenol A unit, —O—, —S—, or —CH₂—. The dianhydride monomer can comprise, but is not limited to, one or more of 4,4′-(4,4′-isopropylidenediphenoxy)bis(phthalic anhydride), 2,3,3′,4′-diphenyl ether tetracarboxylic acid dianhydride, 1,2,4,5-benzenetetracarboxylic anhydride, and 3,3′,4,4′-biphenyltetracarboxylic dianhydride.

The diamine monomer can at least comprise a monomer represented by formula IV.

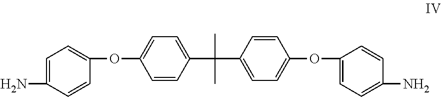 [SMILES: CC(C)(c1ccc(Oc2ccc(N)cc2)cc1)c1ccc(Oc2ccc(N)cc2)cc1]

In one embodiment, the diamine monomer can further comprise a monomer represented by formula V.

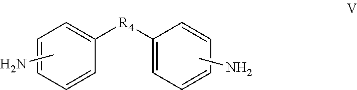

In the formula V, R₄ is a bivalent organic substituent, which can be —(CH₂)n-, —O—, —S—, —CH₂—O—CH₂—, —CH(NH)—(CH₂)ₙ—,

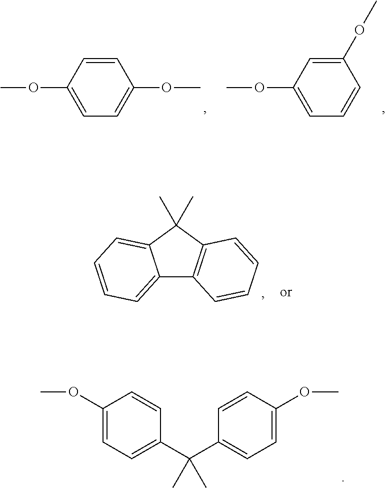

A molar ratio of the monomer of formula IV to the monomer of formula V can be 1:2 to 10:1, and in some embodiments can be 1:1 to 3:1.

A molar ratio of all the dianhydride monomer to all the diamine monomer can be 1:10 to 10:1, and in some embodiments can be 1:2 to 4:1.

A molecular weight of the anode binder can range from about 1000 to about 50000.

One embodiment of a method for making the anode binder comprises a step of polymerizing the dianhydride monomer with the diamine monomer, which specifically can comprise:
mixing the dianhydride monomer and the diamine monomer in an organic solvent to form a mixture, and heating and stirring the mixture to fully carry the reaction thereby obtaining the anode binder.

The diamine monomer can be dissolved in an organic solvent to form a diamine solution. A mass ratio of the diamine monomer to the organic solvent in the diamine solution can be 1:100 to 1:1, and can be 1:10 to 1:2 in some embodiments.

The dianhydride monomer can be dissolved in an organic solvent to form a dianhydride solution. A mass ratio of the dianhydride monomer to the organic solvent in the dianhydride solution, can be 1:100 to 1:1, and can be 1:10 to 1:2 in some embodiments.

The organic solvent can dissolve the diamine monomer and the dianhydride monomer, such as N,N-dimethylformamide, N,N-dimethylacetamide, propylene carbonate, and N-methyl-2-pyrrolidone.

A pump can be used to transfer the dianhydride solution to the diamine solution or vice versa. After the mixing, the stirring can continue for a period of time to form a complete reaction. The stirring can last for about 2 hours to about 72 hours, and about 12 hours to about 24 hours in some embodiments. The temperature of the polymerizing can be at about 160° C. to about 200° C.

During the polymerizing, a catalyst can be added. The catalyst can be at least one of benzoic acid, benzenesulfonic acid, phenylacetic acid, pyridine, quinoline, pyrrole, and imidazole. A mass percentage of the catalyst to a sum of the dianhydride monomer and the diamine monomer can be about 0.5% to about 5%.

First, the dianhydride monomer and the diamine monomer can be completely dissolved in the organic solvent, and then heated to a temperature of about 30° C. to about 60° C. at which the mixture is stirred for about 1 hour to about 10 hours, and 2 hours to 4 hours in some embodiments. The catalyst is then added to the mixture followed by heating the mixture to a temperature of about 160° C. to about 200° C. at which the mixture is stirred for about 6 hours to about 48 hours, and 12 hours to 24 hours in some embodiments, to obtain the polymer.

After the reaction, the anode binder can be purified by washing the obtained polymer with a cleaning solvent, and dried. The catalyst and the organic solvent are soluble to the cleaning solvent, and the anode binder is insoluble to the cleaning solvent. The cleaning solvent can be water, methanol, ethanol, a mixture of methanol and water, or a mixture of ethanol and water (a concentration of the methanol or the ethanol can be 5 wt % to 99 wt %).

One embodiment of an anode electrode material comprises an anode active material, a conducting agent, and the above-described anode binder, which are uniformly mixed with each other. A mass percentage of the anode binder in the cathode electrode material can be in a range from about 0.01% to about 50%, such as from about 1% to about 20%.

The anode active material can be at least one of lithium titanate, graphite, mesophase carbon microbeads (MCMB), acetylene black, carbon fibers, carbon nanotubes, and cracked carbon. The conducting agent can be carbonaceous materials, such as at least one of carbon black, conducting polymers, acetylene black, carbon fibers, carbon nanotubes, and graphite.

The conducting agent can be carbonaceous materials, such as at least one of carbon black, conducting polymers, acetylene black, carbon fibers, carbon nanotubes, and graphite.

One embodiment of a lithium ion battery comprises a cathode electrode, an anode electrode, a separator, and an electrolyte liquid. The cathode electrode and the anode electrode are spaced from each other by the separator. The cathode electrode can further comprise a cathode current collector and the cathode electrode material located on a surface of the cathode current collector. The anode can further comprise an anode current collector and an anode electrode material located on a surface of the anode current collector. The anode electrode material and the cathode electrode material are opposite to each other and spaced by the separator.

The cathode electrode material comprises a cathode active material, a conducting agent, and a cathode binder, which are uniformly mixed with each other. The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The cathode binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone (NMP), N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### Example 1

In molar ratio, 0.4 parts of 2,2′-bis(4-aminophenoxyphenyl)propane (BAPP), 0.6 parts of 4,4′-oxydianiline (ODA), and m-cresol as the organic solvent are added in a triple-neck flask (a solid content of the solution is about 10%), stirred at room temperature to dissolve completely. 1 part of 2,3,3′,4′-diphenyl ether tetracarboxylic acid dianhydride is then added and dissolved completely. The solution is heated to about 50° C. and reacted for about 4 hours followed by adding 1.5 mL of benzoic acid as the catalyst. Then the solution is heated to about 180° C. and reacted for about 24 hours. Finally, the reaction is terminated and the solution is precipitated in methanol to obtain the cathode anode binder, which is a fiber shaped polymer represented by formula VI.

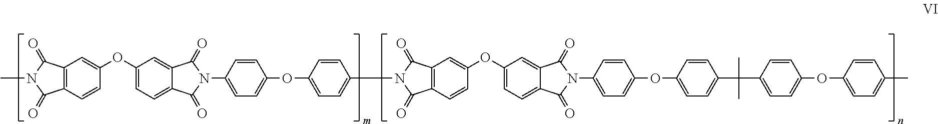

### Example 2

85% of anode graphite, 5% of the anode binder obtained in Example 1, and 10% of the conducting graphite by mass percent are mixed and dispersed by the NMP to form a slurry. The slurry is coated on a copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1(v/v/v). The anode electrode, the counter electrode, and the electrolyte liquid are assembled to form a lithium ion battery.

### Example 3

87% of anode graphite, 3% of the anode binder obtained in Example 1, and 10% of the conducting graphite by mass percent are mixed and dispersed by the NMP to form a slurry. The slurry is coated on a copper foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1(v/v/v). The anode electrode, the counter electrode, and the electrolyte liquid are assembled to form a lithium ion battery.

### Comparative Example 1

85% of anode graphite, 5% of PVDF as the binder, and 10% of the conducting graphite by mass percent are mixed and dispersed by the NMP to form a slurry. The slurry is coated on a copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1(v/v/v). The anode electrode, the counter electrode, the electrolyte liquid are assembled to form a lithium ion battery.

### Comparative Example 2

87% of anode graphite, 3% of PVDF as the binder, and 10% of the conducting graphite by mass percent are mixed and dispersed by the NMP to form a slurry. The slurry is coated on a copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1(v/v/v). The anode electrode, the counter electrode, and the electrolyte liquid are assembled to form a lithium ion battery.

Cycling Performance Test of Batteries

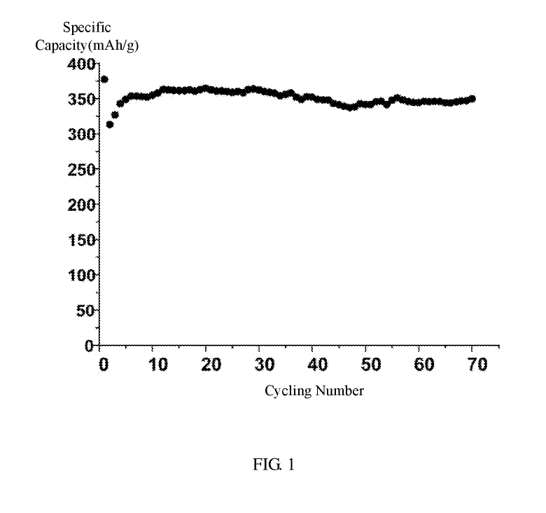

The test conditions are as follows: in the voltage range of 0.005V to 2V, the batteries are charged and discharged at a constant current rate (C-rate) of 0.1 C. The cycling performance of the lithium ion battery in Example 2 for the first 70 cycles is shown in FIG. 1. The discharge efficiency of the first cycle, the discharge specific capacity at the 100^{th} cycle, and the capacity retention at the 100^{th} cycle of the lithium ion batteries in Examples 2, 3, and Comparative Examples 1, 2 are shown in Table 1. It can be seen that the cycling performances are substantially the same in the batteries using the anode binder of Example 1 and the conventional PVDF binder. The rapid decline of the capacity in the Comparative Example 2 may attribute to a decrease of a binding force. In contrary, as the present anode binder has a binding force superior than that of PVDF, the battery of Example 3 having the present anode binder has better capacity retention than the battery of Comparative Example 2 having PVDF as the binder, which has the same percentage in the anode material.

TABLE 1

| | | Discharge specific | Capacity |
|---|---|---|---|
| | Efficiency (%) at 1st | capacity (mAh/g) at | retention (%) |
| | cycle | 100^{th} cycle | at 100^{th} cycle |
| Example 2 | 70 | 333 | 91 |
| Example 3 | 73 | 330 | 90 |
| Comparative | 87 | 332 | 95 |
| Example 1 | | | |
| Comparative | 79 | 286 | 84 |
| Example 2 | | | |

Liquid Absorption Rate Test

The pristine anode electrodes of Example 2 and Comparative Example 1 are first weighed, and then immersed in an electrolyte liquid for about 48 hours. The anode electrodes are taken out from the electrolyte liquid, and the residual electrolyte liquid are wiped off from the surface, and then the anode electrodes are weighed again. Liquid absorption rate (R) is calculated by R=(M_{after}−M_{before})/M_{before}×100%, wherein M_{before} is the mass of the anode electrode before being immersed in the electrolyte liquid, and M_{after} is the mass of the anode electrode after being immersed in the electrolyte liquid. The R value for Example 2 is 34.5%, and the R value for Comparative Example 1 is 21.0%.

Binding Force Test

The binding force tests are carried out for the anode electrodes of Example 2 and Comparative Example 1, respectively. Adhesive tape having a width of 20 mm±1 mm is used. First, 3 to 5 outer layers of the adhesive tape are peeled off, and then more than 150 mm long of the adhesive tape is taken. The adhesive tape does not contact a hand or any other object. One end of the adhesive tape is adhered to the anode electrode, and the other end of the adhesive tape is connected to a holder. A roller under its own weight is rolled on the anode electrode at a speed of about 300 mm/min back and forth over the entire length of the anode electrode three times. The test is carried out after resting the anode electrode in the test environment for about 20 minutes to about 40 minutes. The adhesive tape is peeled from the anode electrode by a testing machine at a speed of about 300 mm/min±10 mm/min. The test results are shown in Table 2, revealing that the anode binder of Example 2 has a stronger binding force than the PVDF of Comparative Example 1.

TABLE 2

| | Sample | | |
|---|---|---|---|
| Sample | Thickness/μm | Sample Width/mm | Maximum load/N |
| Example 2 | 68 ± 2 | 20 | 0.717 |
| Comparative | 68 ± 2 | 20 | 0.183 |
| Example 1 | | | |

In the present disclosure, the polymer obtained by polymerizing the dianhydride monomer with diamine monomer can be used as an anode binder in the lithium ion battery. The polymer has a small effect on the charge and discharge cycling performance of the lithium ion battery and can be used as the anode binder.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An anode electrode material comprising an anode binder, the anode binder comprising a polymer obtained by polymerizing a dianhydride monomer with a diamine monomer, wherein the dianhydride monomer comprises a monomer selected from the group consisting of monomers represented by formulas I, II, III, and combinations thereof, the diamine monomer comprises a first monomer represented by formula IV,

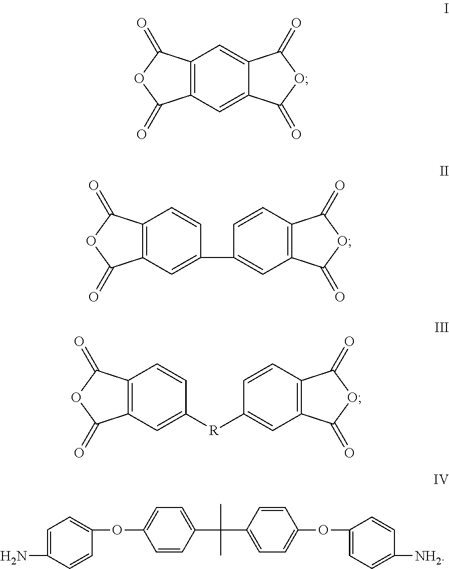

2. The anode electrode material of claim 1, wherein the R in formula III is selected from the group consisting of bisphenol A unit, —O—, —S—, and —CH₂—.

3. The anode electrode material of claim 1, wherein the dianhydride monomer is selected from the group consisting of 4,4′-(4,4′-isopropylidenediphenoxy)bis(phthalic anhydride), 2,3,3′,4′-diphenyl ether tetracarboxylic acid dianhydride, 1,2,4,5-benzenetetracarboxylic anhydride, 3,3′,4,4′-biphenyltetracarboxylic dianhydride, and combinations thereof.

4. The anode electrode material of claim 1, wherein the diamine monomer further comprises a second monomer represented by formula V,

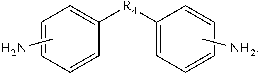

5. The anode electrode material of claim 4, wherein the R₄ in formula V is selected from the group consisting of —(CH2)n-, —O—, —S—, —CH₂—O—CH₂—, —CH(NH)—(CH₂)ₙ—,

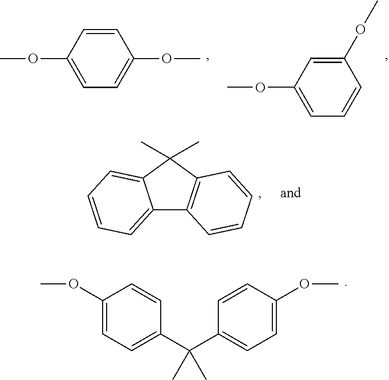

6. The anode electrode material of claim 4, wherein a molar ratio of the first monomer to the second monomer is 1:2 to 10:1.

7. The anode electrode material of claim 4, wherein a molar ratio of the first monomer to the second monomer is 1:1 to 3:1.

8. The anode electrode material of claim 1, wherein a molar ratio of the dianhydride monomer to the diamine monomer is 1:10 to 10:1.

9. The anode electrode material of claim 1, wherein a molar ratio of the dianhydride monomer to the diamine monomer is 1:2 to 4:1.

10. The anode electrode material of claim 1 having a molecular weight in a range from about 1000 to about 50000.

11. The anode electrode material of claim 1 further comprising an anode active material and a conducting agent.

12. The anode electrode material of claim 11, wherein a mass percentage of the anode binder is in a range from about 0.01% to about 50%.

13. The anode electrode material of claim 11, wherein a mass percentage of the anode binder is in a range from about 1% to about 20%.

14. A lithium ion battery comprising:
a cathode electrode;
an electrolyte;
a separator; and
an anode electrode, the anode electrode comprising an anode active material, a conducting agent, and an anode binder,
wherein the anode binder comprises a polymer obtained by polymerizing a dianhydride monomer with a diamine monomer, the dianhydride monomer comprises a monomer selected from the group consisting of monomers represented by formulas I, II, III, and combinations thereof, the diamine monomer comprises a first monomer represented by formula IV,

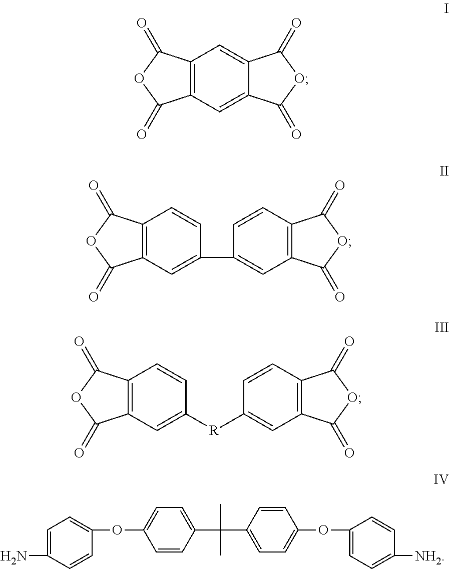

15. The lithium ion battery of claim 14, wherein the anode binder is consisted of the polymer.

16. The lithium ion battery of claim 14, wherein the cathode active material is selected from the group consisting of lithium titanate, graphite, mesophase carbon micro beads (MCMB), acetylene black, mesocarbon miocrobead, carbon fibers, carbon nanotubes, cracked carbon, and combinations thereof.
